(19) United States
(12) Patent Application Publication
(10) Pub. No.: US 2012/0256024 A1
(43) Pub. Date: Oct. 11, 2012

(54) EASY SEALING PILL CRUSHER POUCH FOR USE WITH A PILL CRUSHER

(75) Inventors: Mark ENGEL, Encino, CA (US); Song Yang, Shanghai (CN)

(73) Assignee: Tiger Medical Products (US), Inc., Encino, CA (US)

(21) Appl. No.: 13/452,853

(22) Filed: Apr. 21, 2012

Related U.S. Application Data
(63) Continuation-in-part of application No. 11/818,784, filed on Jun. 15, 2007.
Application No. 11/818,784 is a continuation-in-part of application No. 29/252,170, filed on Jan. 19, 2006, now Pat. No. D551989.

(51) Int. Cl. B02C 19/00

(52) U.S. Cl. 241/26; 241/168

(57) ABSTRACT

A pill crusher pouch having ribs and intersecting straight bottom seal portions. The pill crusher pouch is used for holding a pill or tablet to be crushed by a pill crusher device so as to form a powder that can easily be dispensed and provided to a patient. The ribs increase the strength of the walls of the pouch, preventing rupture. A curved flap is folded over into an open end and resiliently pressing against the inside surface of an opposing sidewall sealing the pouch.

### RELATED APPLICATION

This application is a continuation-in-part of application Ser. No. 11/818,784 filed Jun. 15, 2007, which is a continuation-in-part of application Ser. No. 29/252,170 filed Jan. 19, 2006.

### FIELD OF THE INVENTION

The present invention relates to a pouch used to contain a pill to be crushed for dispensing to a patient or mixing with other medicaments, and in particular to a stronger pouch that is less prone to breaking and is capable of holding and dispensing the pulverized or powdered pill efficiently.

### BACKGROUND OF THE INVENTION

Small plastic pouches have been used to contain a pill to be crushed. It is often desirable that in dispensing a medicament in the form of a pill that it be crushed or pulverized to a powder form for even mixing or dispensing to a patient. Often, this has been done by placing the pill into a small pouch and placing the pouch in a pill crusher having an anvil and movable platen. A mechanical advantage is used so as to apply a force to the pouch and pill contained therein, crushing the pill between the anvil and movable platen. One such pill crushing device is disclosed in U.S. Pat. No. 5,915,637 entitled “Pill Crusher” and issuing to Parsons on Jun. 29, 1999. Therein disclosed is a pill crusher having an anvil fixed to a base and a movable handle compression link pivotally coupled to the base and a platen providing a mechanical advantage for crushing a pill placed between the anvil and movable platen. Also disclosed therein is a pill pouch having a straight line bottom seal. Another pouch is disclosed in U.S. Pat. No. 7,051,963 entitled “Pill Crusher Pouch and Method of Using Same” issuing to Buckley on May 30, 2006, which is herein incorporated by reference. Therein disclosed is a pill crusher pouch having a cup like seal line that provides a rounded or circular like cornerless bottom that does not have any sharp pointed corners, which is herein incorporated by reference.

While the prior pouches have been suitable for crushing pills within a pill crusher, upon occasion the pill pouches may rupture or break due to the extreme forces used in crushing the pill to a powder form. The walls of the pouch or seal may rupture, causing contamination of the pill crusher and loss of potentially expensive medicine. Should the pill pouch rupture, cross-contamination may result, as well as uncertainty as to the content of the pill powder and dose. Therefore, it is important that a pill pouch be used that is less prone to breakage. Additionally, while a cup like or curved seal does help to prevent powder from accumulating in the corners of a straight line sealed pouch, it may be more prone to rupture since there is less space for the pills to travel in the pouch during the crushing actions.

Additionally, pill crushing pouches have been difficult to seal conveniently and yet allow easy access to or dispensing of the crushed pill. Should the pill crushing pouch be sufficiently tilted or dropped some of the crushed pill may inadvertently spill from the pill crushing pouch. Also, if the crushed pill is dispensed along an edge of a pill crushing pouch, often larger pieces of crushed pill may get caught and not dispense or make it difficult to provide smooth consistent dispensing of a desired quantity of a crushed pill. If only a portion of the crushed pill is desired there is no easy way to seal the pill crusher pouch for later dispensing of a remaining portion of the crushed pill.

Therefore, there is a need to obtain a stronger pouch that has improved strength, and that provides easier sealing, storing, holding, and dispensing of crushed pill that is also inexpensive to manufacture.

### SUMMARY OF THE INVENTION

The present invention is directed to a pouch used for holding a pill to be crushed in a pill crusher device that is resistant to rupturing or breakage. The pill pouch of the present invention has different ribbing structures that increase the strength of the walls of the pill pouch so as to prevent breakage and a bottom seal that is less prone to rupturing and has a shape to more completely dispense the powder of the pulverized pill.

Ribs of increased material thickness are used on the walls of the pouch to increase strength of the pouch and prevent rupturing.

In one embodiment, a composite rib is utilized using a strong fiber material contained therein. In another embodiment, a fiber material is encapsulated and sealed within the wall of the pouch.

In another embodiment, a bottom seal has a substantially straight portion and angled end portions forming an obtuse corner so as to improve seal strength and permit more complete dispensing of the powder of the pulverized pill.

In another embodiment, the seal is formed from two straight portions forming an angled center portion and having angled end portions.

In another embodiment, the seal is formed by two straight portions intersecting at an obtuse angle.

The bottom seals of the present invention provide a plurality of straight sections connected by obtuse angles, improving strength and permitting easy dispensing of the powder from a pulverized pill.

In another embodiment, rounded or curved edges of sides of the pouch form an opening that facilitates sealing, storing, and dispensing of a crushed or pulverized pill. Either rounded or curved edges of a side may be folded over and into the opening so as to be held against the opposing side. The resilience of the folded rounded edge of the side forces the rounded edge against the opposing sidewall sealing the opening preventing spilling of the crushed pill. Upon unfolding the rounded or curved edge so as to form an opening and flexing creased side edges of the pouch together forms the rounded or curved edges of the pouch into a concave shoot facilitating easy and accurate dispensing of the crushed or pulverized pill from the opening of the pouch.

Accordingly, it is an object of the present invention to reduce the possibility of breakage of a pill pouch during the crushing of a pill contained therein.

It is another object of the present invention to provide an efficient pill pouch that permits substantially complete dispensing of the powder formed from the pulverized pill.

It is an object of the present invention to provide a stronger wall structure and seal configuration for a pill pouch.

It is yet another object of the present invention to provide a pill pouch that is easily sealed.

It is another advantage of the present invention that it provides more reliable dosing of medicament.

It is yet another advantage of the present invention that it may be tilted or inverted without spilling the crushed pill contained therein.

It is a feature of the present invention that ribs are formed in the walls of the pouch, adding to the strength of the pouch and preventing unintentional rupture.

It is another feature of the present invention that straight seal portions are connected by obtuse angles.

It is yet another feature of the present invention that a rounded or curved edge is folded over and into the opening of the pill pouch.

It is yet another feature of the present invention that the unfolded rounded or curved edge and side forms a shoot for smooth dispensing of the crushed pill.

These and other objects, advantages, and features will become more readily apparent in view of the following more detailed description.

### BRIEF DESCRIPTION OF THE DRAWINGS

FIG. 1 is a perspective view of one embodiment of the present invention.

FIG. 2A schematically illustrates a partial view of a wall section of the embodiment illustrated in FIG. 1.

FIG. 2B is a schematic view illustrating a partial view of a wall section illustrating another embodiment of a rib structure.

FIG. 2C is a schematic partial view of a wall section illustrating another embodiment of a rib structure.

FIG. 3 is an elevational view schematically illustrating a seal configuration of another embodiment of the present invention.

FIG. 4 is an elevational view schematically illustrating another seal configuration in another embodiment of the present invention.

FIG. 5 is an elevational view schematically illustrating another embodiment of the present invention having horizontal ribs.

FIG. 6 is an elevational view schematically illustrating another embodiment of the present invention having cross hatched ribs.

FIG. 7 is an elevational view schematically illustrating another embodiment of the present invention having diagonal ribs.

FIG. 8 is a perspective view of another embodiment a pill pouch of the present invention having a curved open side edge.

FIG. 9 is an illustrative view of a pill being placed within the pill pouch.

FIG. 10 is an illustrative view of the folding over and insertion of a curved open side edge into the open end of the pouch.

FIG. 11 is a perspective view illustrating the sealed pill pouch with a crushed pill contained therein.

FIG. 12 is an illustrative view of the pill pouch inverted holding the crushed pill therein.

FIG. 13 is an illustrative view of the formation of a shoot for smoothly dispensing the crushed pill.

### DETAILED DESCRIPTION OF THE PREFERRED EMBODIMENTS

FIG. 1 is a perspective view illustrating one embodiment of a pill pouch 10 of the present invention. The pill pouch 10 has a seal 12 at a sealed end and opening 14 at an open end. Placed on walls 24 are longitudinal ribs 16. The longitudinal ribs 16 extend the entire length of the walls 24 of pouch 10. Seal 12 may be formed by any conventional sealing method such as heat sealing, ultrasonic welding, or other known sealing techniques. The pill pouch 10 is preferably made of a thin plastic tube of material such as polyethylene. The pill pouch 10 is preferably made of a translucent material, but may be opaque. The seal 12 has a substantially straight portion 18. The substantially straight portion 18 extends for a substantial portion of the bottom lateral distance. Angled bent portions 20 are formed at either end of the straight portions 18 and form an obtuse angle 22 at the vertex or intersection of the straight portion 18 and the angled end portions 20. The obtuse angle 22 is preferably greater than one hundred and thirty-five degrees.

The substantial straight portion 18 results in an easily fabricated strong seal portion that is less prone to rupture than curved or non-straight portions that sometimes may not seal completely or may have small areas where forces may be concentrated, creating a rupture. Therefore, forces generating in the process of pulverizing a pill may be spread out along the length of the substantial straight portion 18. The substantially straight portion 18 uniformly distributes the forces so as to prevent rupture of the seal. The angled end portions 20 form an obtuse angle 22 with the straight portion 18. This structure helps to prevent powder from the pulverized pill from accumulating and facilitate complete dispensing from the pouch 10.

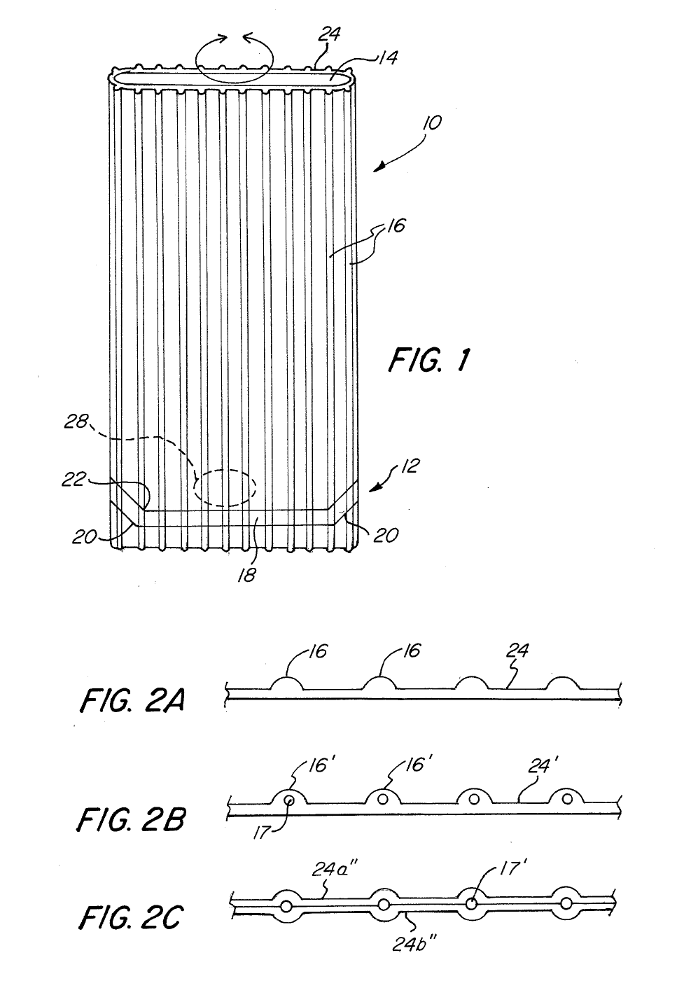

FIG. 2A schematically illustrates a portion of the wall 24 of the pouch 10 illustrated in FIG. 1. For reasons of economy, the wall 24 is relatively thin and therefore sometimes prone to rupture or piercing due to sharp fragments of a broken pill. The pill 28 may preferably have a size that extends across several ribs 16. That is the lateral distance between ribs 16 is less than the diameter of a pill 28. Therefore, the ribs 16 greatly facilitate the structural strength of the pouch across the surface of the pill 28. The ribs 16 are raised portions of increased thickness of material that can improve strength without the need for increasing the thickness of the entire wall 24.

FIG. 2B schematically illustrates another embodiment of a pouch having a composite rib structure. Pouch wall 24′ has formed thereon ribs 16′ having imbedded therein a fiber material 17. The fiber material 17 generally may be made of a material much stronger than the material of the wall 24′ and surrounding rib structure 16′. This composite structure greatly improves the strength of the walls 24′ of the pouch.

FIG. 2C schematically illustrates a wall portion of another embodiment of the present invention. In this embodiment, the wall is formed by a first sheet 24″a and a second sheet 24″b having a fiber material 17′ placed there between. The two sheets 24″a and 24″b are sealed together, encapsulating the fiber material 17′. Accordingly, the fiber material 17′ is imbedded in the wall of the pill pouch providing substantially enhanced structural strength preventing rupture of the wall.

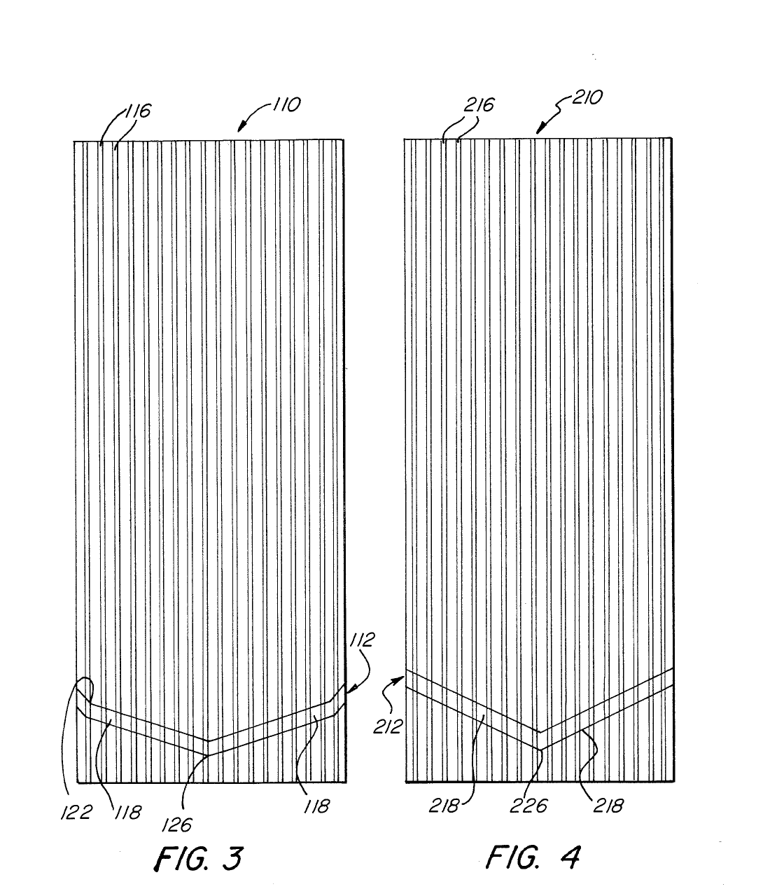

FIG. 3 is another embodiment of a pill pouch 110 having longitudinal ribs 116 and a bottom seal 112. The ribs 116 can be comprised of any of the configurations as illustrated in FIGS. 2A-C. The bottom seal 112 is formed from two substantially straight portions 118, intersecting at a center angled portion 126. Slightly curved end portions 120 form an obtuse angle 122 with the substantially straight portions 118. The angled center portion 126 preferably forms a relatively large angle, generally greater than 160° but less than 180°.

FIG. 4 schematically illustrates another embodiment of the present invention. In this embodiment, the pouch 210 has longitudinal ribs 216 and a bottom seal 212. The bottom seal 212 is formed by two substantially straight portions 218, intersecting at an obtuse angle 226.

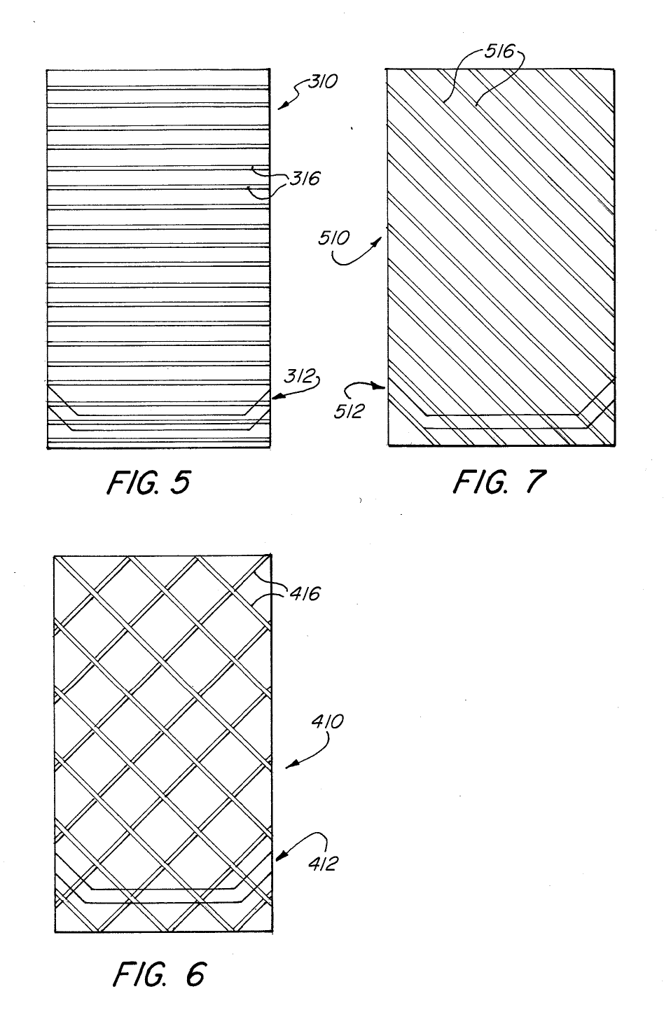

FIG. 5 illustrates another embodiment of the present invention. In this embodiment, a pill pouch 310 has horizontal or lateral ribs 316 and a bottom seal 312.

FIG. 6 illustrates another embodiment of the present invention. In this embodiment, a pill pouch 410 has cross hatched ribs 416 and a bottom seal 412.

FIG. 7 is yet another embodiment of the present invention. In this embodiment a pill pouch 510 has diagonal ribs 516 and a bottom seal 512.

It should be appreciated from FIGS. 5-7 that various differing configurations of ribs may be used while still achieving the increased strength of the walls.

Additionally, differing configurations of seals having substantially straight portions connected by obtuse angles may be utilized to provide a strong seal that is less prone to rupture and a configuration that facilitates substantially complete dispensing of the powder formed from the pulverized pill.

In another embodiment of the present invention the opening of the pill crusher pouch can be easily sealed. This prevents a crushed pill from being spilled from the pill crusher pouch. This embodiment of the present invention permits easy sealing and smooth dispensing of the crushed pill.

FIGS. 8-13 illustrate this embodiment of the invention and its operation. A pouch 210 has a bottom seal 212 and an opposing opening 214. Ribs 216 are formed on sidewalls 224. Creased edges 228 join the opposing sidewalls 224 together along a longitudinal edge. At the opening 214 are formed rounded or curved sidewall edges 230. The rounded or curved sidewall edges 230 on the sidewalls 224 form rounded or curved flaps 232. The rounded or curved sidewall edges 230 come together at intersection 234 adjacent the creased edge 228.

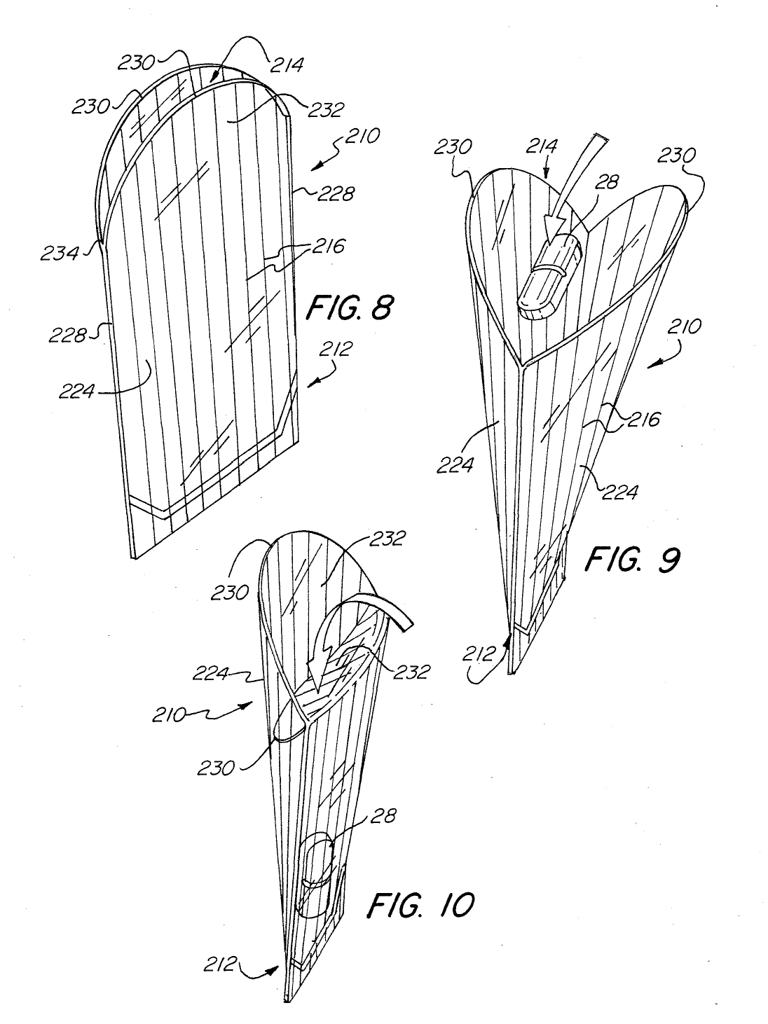

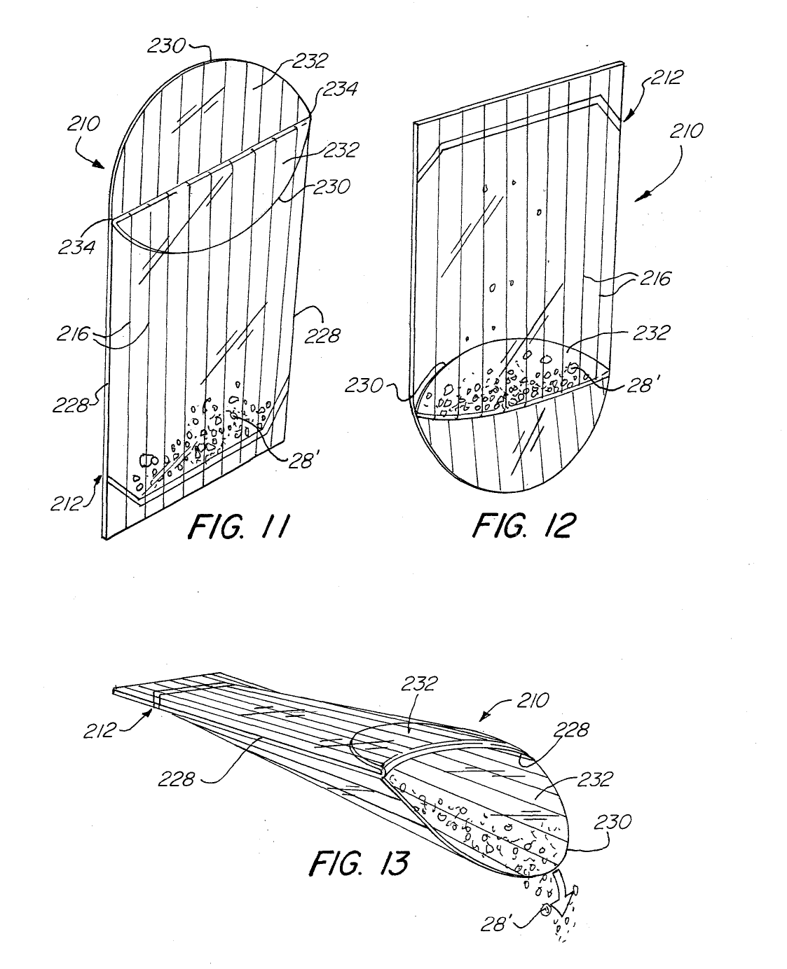

The operation and advantages of this embodiment of the invention is readily appreciated with reference to the FIGS. 8-13. FIG. 8 illustrates the empty pill crusher pouch 210. FIG. 9 illustrates the placement of a pill 28 within the opening 214 of the pill crusher pouch 210. FIG. 10 illustrates the folding over of one of the opposing rounded or curved flaps 232 so that it contacts an inside surface of an opposing sidewall 224. The rounded or curved sidewall edge 230 conforms to the slightly curved surface of the sidewall 224 so as to seal the opening 214 of the pill crusher pouch 210. The pill crusher pouch 210 may be placed in a pill crushing device so that the pill 28 contained therein is crushed or pulverized forming a crushed pill 28′ contained in the bottom of the pill crusher pouch 210 adjacent the bottom seal 212. The rounded or curved sidewall edge 230 of the rounded or curved flap 232 extends below the intersection 234 of the creased edges 228. The natural resiliency and resistance to folding of the rounded or curved flap 232 causes the rounded or curved flap 232 to press against the inside surface of the opposing sidewall 224 providing a seal and angled surface so as to prevent the crushed pill 28′ from spilling or falling out of the pill crusher pouch 228. As illustrated in FIG. 12, even if the pill crusher pouch 210 is inverted the crushed pill 28′ is prevented from falling out and is caught by the rounded or curved flap 232. This prevents the crushed pill 28′ from falling out of the open end or opening 214 of the pill crusher pouch 210.

FIG. 13 illustrates another feature of the present invention and ease of dispensing the crushed pill 28′ from the pill crusher pouch 210. When the crushed pill 28′ is desired to be dispensed from the pill crusher pouch 210, the creased edges 228 may be pressed together thereby forcing one sidewall 224 to flex and bow forming a chute and providing a gap between the rounded or curved sidewall edge 230 and the inside surface of sidewall 224 so as to permit the crushed pill 28′ to smoothly dispense along the chute formed by an opposing unfolded rounded or curved flap 232.

Accordingly, this feature of the present invention has the advantage that it is easily sealed by simply folding over the rounded or curved flap 232 sealing the open end or opening 214 with ease and yet permits easy dispensing merely by squeezing together the creased edges 228 so as to form a chute from an unfolded opposing one of the rounded or curved flaps 232.

The rounded or curved flaps 232 provide many benefits. The rounded or curved side wall edge 230 pushes against and matches the curve of the inside of the sidewall 224. The ribs 216 stiffen the rounded or curved flap 232 so as aid in its resiliency and force pressing against the inside surface of the sidewall 224. This helps to naturally seal the pill crusher pouch 210 as well was aiding the sidewalls 224 to curve so as to accommodate the shape of the rounded or curved sidewall edge 230 providing a seal. In addition the opposing rounded or curved flaps 232 enables a chute to be formed by an unfolded rounded or curved flap 232 by squeezing together the creased edges 228. This permits the crushed pill 28′ to be smoothly dispensed along the chute providing consistent dispensing. This is contrary to prior art pouches that dispense a crushed pill along a creased edge. The dispensing along the chute decreases the chance of broken pieces of the crushed pill from catching in the creased edges. Dispensing the crushed pill 28′ along the chute assures more uniform and accurate dispensing of the crushed pill 28′.

The different embodiments of the present invention provide a relatively simple, cost effective, and strong pill pouch that can be used in a pill crusher device. The present invention provides easy sealing and dispensing of a crushed pill that requires little dexterity, and therefore can be done easily. The present invention improves the safety and reliability of pill pouches. The present invention therefore improves upon the previously known pill pouches and advances the art.

While several embodiments have been illustrated and described with respect to the present invention, it should be appreciated that various modifications may be made without departing from the spirit and scope of this invention.

What is claimed is:

1. A pill crusher pouch comprising:
a tube forming opposing sidewalls having an open end and a sealed end; and
a curved sidewall edge formed on each of the opposing sidewalls at the open end,
whereby said curved sidewall edge may be fold inward so that said curved sidewall edge touches an inside surface of an opposing sidewall of said tube.

2. A pill crusher pouch as in claim 1 further comprising:
ribs placed on the sidewalls of said tube,
whereby said ribs add resilience to the sidewalls of said tube aiding in said curved sidewall edge contacting the inside surface of an opposing sidewall of said tube.

3. A pill crusher pouch as in claim 1 wherein:
said tube is made of plastic.

4. A pill crusher pouch as in claim 3 wherein:
said ribs extend longitudinally on the opposing sidewalls.

5. A pill crusher pouch for use in crushing a pill within a pill crushing device comprising:
a pouch having opposing sidewalls attached by creased edges with each opposing sidewall having a curved sidewall edge adjacent an opening forming a curved edge flap having a curved edge extending to the creased edges;
a bottom seal placed on an end of said pouch opposite the curved sidewall edge; and
ribs placed on the opposing sidewalls of said pouch and extending to the curved sidewall edges, whereby said ribs provide a resilience to bending of the curved edge flap,
whereby the curved edge flap may be folded into the opening and the resilience of the curved edge flap forces the curved sidewall edge adjacent an opposing sidewall securely sealing the opening and preventing spillage of a crushed pill contained within said pouch.

6. A pill crusher pouch for use in crushing a pill within a pill crushing device as in claim 5 wherein:
said seal comprises a straight portion over a substantial length of a lateral width of said pouch.

7. A pill crusher pouch for use in crushing a pill within a pill crushing device as in claim 5 wherein:
said pouch is made of plastic.

8. A pill crusher pouch for use in crushing a pill within a pill crushing device as in claim 5 wherein:
the curved sidewall edge has a curve matching a formed curved surface of the opposing sidewalls.

9. A pill crusher pouch for use in crushing a pill within a pill crushing device as in claim 5 wherein:
said ribs extend longitudinally on the opposing sidewalls.

10. A method of dispensing a crushed pill comprising the steps of:
placing a pill in a pouch having opposing sidewalls attached by creased edges with each opposing sidewall having a curved sidewall edge adjacent an opening;
folding over one of the curved sidewall edges into the opening so that the one of the curved sidewall edges contacts an opposing sidewall of the pouch;
crushing the pill; and
squeezing the creased edges of the pouch together so as to form a chute from the one of the opposing sidewalls opposite the one of the curved sidewall edges folded over,
whereby a crushed pill is securely retained within the pouch but yet is easily dispensed.
